(19) United States
(12) Patent Application Publication
(10) Pub. No.: US 2003/0046193 A1
(43) Pub. Date: Mar. 6, 2003

(54) Method and system for decentralized logistic management of supply chain networks

(75) Inventors: Peter Aschick, Newtown, CT (US); Thomas Fleck, Klein-Winternheim (DE); Michael Kaltenbach, Mainz-Kostheim (DE); Udo Kleemann, Stadecken-Elsheim (DE); Norbert Liebisch, Sprendlingen (DE)

Correspondence Address: Samuel A. Kassatly, 6819 Trinidad Drive, San Jose, CA, 95120, US

(73) Assignee: International Business Machines Corporation, Armonk, NY

(21) Appl. No.: 10/163,038

(22) Filed: Jun. 5, 2002

(30) Foreign Application Priority Data
Aug. 31, 2001 (EP) EP01120946.7

(51) Int. Cl. G06F 17/60

(52) U.S. Cl. 705/28

(57) ABSTRACT

A system and a corresponding method for the logistic management of supply chains of digitally networked suppliers, wherein supply chain participants that are linked directly within the supply chain are identified and grouped, and wherein, on the side of each of the grouped supply chain participants, logistic requirements for fulfilling local supply activities to the other supply chain participant of the group are determined, logistic information between those two supply chain participants exchanged, and the local logistic requirements on the side of each of the grouped supply chain participants dependent on the contents of the exchanged logistic information controlled. The invention enables decentralized management with considerable less efforts than conventional approaches, wherein collaboration and replenishment between collaborating suppliers are accomplished using a network like the Intranet or Internet.

### CROSS-REFERENCE TO RELATED APPLICATION

The present application relates to copending U.S. patent application, Ser. No. 09/910,544, titled “Network-Based Supply Chain Management Method,” Docket No. YOR920010274US1, which was filed on Jul. 20, 2001 by the same assignee as the present application, and which is incorporated herein by reference.

### FIELD OF THE INVENTION

The present invention relates generally to the field of supply chain process management, and more specifically relates to a method and system for managing logistics of a supply chain of digitally networked supply chain participants.

### BACKGROUND OF THE INVENTION

Supply chains usually involve multiple companies, working both competitively and cooperatively to produce, transport and sell products to the consumer. The field of supply chains is understood herein to span from initial suppliers of raw materials through transport and assembly of those raw materials, often performed in warehouses or intermediate bearing facilities. Thus, those different raw materials, products or articles have to be transported in due time to manufacturing plants or assembly centers that combine two or more raw materials via processes that lead to intermediate (semi-finished) or even final products.

Supply chain management further embraces procurement of raw materials and intermediate products, managing storage of such products on pallets or other devices, the warehousing of such products, their transport to intermediate distribution centers, their transportation from such centers to other distribution centers and thence to retailers or the final consumers.

In general, the dynamics of such a supply chain are highly complex. Among the factors entering the behavior of the supply chain are lead times and order cycle times, often governed by the delays associated with manufacture at each step and transport at each step, the topology of the supply chain as a flow network, the uncertainty in demand from the final consumer either in the absence or presence of periodic promotional sales or one or more stock keeping units available.

In addition, supply chains must operate within an environment that has market failures including lack of information, externalities, lack of a market, public goods, transportation costs and monopolies. Further, governmental restrictions like pollution laws, taxes for highways and national defense, and laws governing monopolies play an important role for supply chain management.

In conventional supply chain management each company has to optimize its own piece of the entire supply chain, ignoring any detrimental effects that the decisions may have on its supply chain partners. Accordingly, there exists a need for a supply chain management process that meets the above deficiencies of the existing solutions.

Another approach disclosed in U.S. Pat. No. 6,157,915, proposes a collaborative management of supply chains. An active collaboration technology in an open architectural framework delivers information and decision support tools in a timely, contextual and role sensitive manner to present a collaborative dynamic decision making capability to a community of role players within a supply chain process. This capability is achieved through the integration of the underlying business process, the organization of the role players and the relevant business applications.

This approach particularly proposes collaborative creation of a business scenario by role players having permission to access interactive role sensitive documents for supply, production and distribution of a product, submitting the business scenario via the interactive documents on a distributed network, dynamically formulating a business plan based on the collaboratively created and submitted business scenario and nesting and maintaining the business scenario and the business plan in the interactive documents including updates of the business scenario and the business plan in response to the dynamically formulated business plan.

The above collaborative management approach disadvantageously does not address the particular problem of minimizing the necessary management efforts for managing a complex supply chain infrastructure, in particular in respect of the necessary replenishment cycles on each supply chain level in order to keep the whole supply chain busy.

### SUMMARY OF THE INVENTION

It is therefore an object of the present invention to provide an above referenced method and system for managing supply chains which avoid the mentioned drawbacks and provide a simplified supply chain management of even complex supply chain infrastructures.

It is another object to provide such a method and system which still provide centralized control of an entire supply chain process.

Yet another object is to provide a computer-implemented supply chain management approach.

These objects are attained with an above specified method and system by the features of the independent claims. Advantageous embodiments are subject matter of the subclaims.

The proposed supply chain process includes the steps of identifying at least two supply chain participants in the supply chain being linked directly within the supply chain, grouping the at least two supply chain participants, determining, on the side of each of the at least two grouped supply chain participants, logistic requirements for fulfilling local supply activities to the at least other supply chain participant of the grouped supply chain participant entity, exchanging logistic information between the at least two supply chain participants, and controlling the local logistic requirements on the side of each of the at least two supply chain participants dependent on the contents of the exchanged logistic information.

The idea underlying the invention is to provide a certain level of supplier collaboration and replenishment, i.e. control of goods movement, by way of logistic information exchange between suppliers directly interlinked within the entire supply chain network and thus to defer responsibility for fulfillment of local logistic supply chain requirements from the supplied company to the supply chain participants, thus to decentralize those local management efforts but to keep control of the entire supply chain process at the supplied company.

The invention particularly provides a computer-implemented or computer-assisted supply chain management concept where information relating to logistic fulfillment of local supply chain partners within the whole supply chain is exchanged only between those two interlinked supply chain participants. The invention therefore enables decentralized management with considerable less efforts than the prior art approaches wherein collaboration and replenishment between collaborating suppliers is accomplished using a computer network like an Intranet or the Internet.

According to a preferred embodiment, all supply chain participants have access, via the Internet, to a logistic management database in order to communicate with each other, to exchange the above mentioned logistic information and to exchange supply preview information and goods movement by way of a may be standardized graphical user interface.

Using the present invention, supply chain partners have only to meet local supply requirements between their direct supply chain partners and not to consider supply requirements of other supply chain partners located in other areas of the entire supply chain. On the other hand, the supplied company has not to be involved in those local supply chain processes and thus has removed the burden from managing the whole supply chain.

In addition, the supply chain process according to the invention enables an increased exchange of supply materials within a whole supply chain, but decreased transport cost efforts and lower costs caused by grown too old stocks of supply materials, and thus also avoids express deliveries between neighbored supply chain participants required in order to balance supply bottlenecks between those. Further it allows for enhanced logistic flexibility of all supply chain participants and generates improved readiness for supply activities on the side of all supply chain participants.

### BRIEF DESCRIPTION OF THE DRAWINGS

Referring to the accompanied drawings, the present invention is described in the following in more detail by way of embodiments from which further features and advantages of the invention become evident, wherein:

FIG. 1 is an overview block diagram illustrating a supply chain structure having implemented a supply chain management (SCM) process according to the invention;

FIG. 2 is another block diagram depicting a computer-implemented system for managing a supply chain according to a preferred embodiment of the invention;

FIG. 3 is comprised of FIGS. 3A, 3B, 3C, and represents flow diagrams that illustrate a typical multi-tier communication protocol to be used between supply chain participants according to the invention;

FIG. 4 is comprised of FIGS. 4A, 4B (formed of FIGS. 4B-1, 4B-2, 4B-3), and 4C, and represents schematic drawings depicting a graphical user interface structure in accordance with an embodiment of the invention;

FIG. 5 is comprised of FIGS. 5A, 5B, 5C, 5D, and shows exemplary screenshots of a graphical user interface according to the invention for scheduling, drafting and exchanging logistic fulfillment information between interlinked supply chain participants; and

FIG. 6 shows an exemplary Replenishment Service Center (RSC) network environment in accordance with the invention.

### DETAILED DESCRIPTION OF PREFERRED EMBODIMENTS

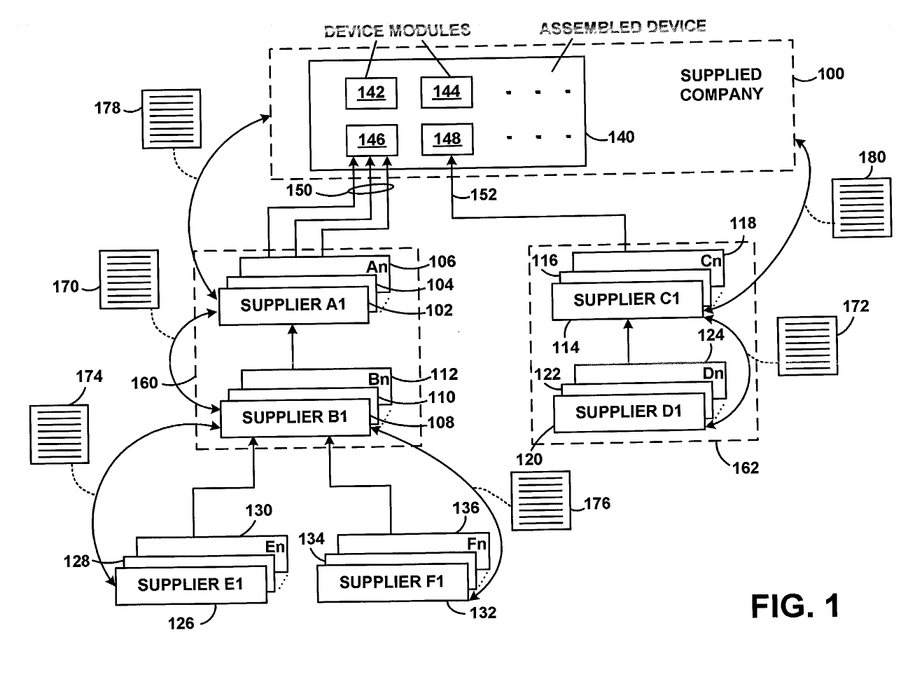

The supply chain structure schematically shown in FIG. 1 Includes a supplied company 100 and a number of suppliers 102-136 A1, . . . , An-F1, . . . ,Fn. The shown supply chain is used for providing supplies for a device 140 to be assembled out of a number of device modules 142-148 at the supplied company 100. The device 140 to be assembled is assumed to consist of a the multitude of device modules 142-148, each of these modules 142-148, in the present embodiment, provided by a subchain 150, 152 of suppliers of the number of suppliers 102-136 A1, . . . , An-F1, . . . ,Fn.

In accordance with the invention, the whole supply chain is structured into groups 160, 162, each group consisting of only two subgroups, e.g. A1, . . . ,An 102-106 and B1, . . . ,Bn 108-112, or 114-118 and 120-124 of suppliers which are interlinked or neighbored within the supply chain in the sense that e.g. suppliers B1, . . . ,Bn are subsuppliers of suppliers A1, . . . ,An, suppliers E1, . . . ,En and F1, . . . ,Fn are subsuppliers of suppliers B1, . . . ,Bn, etc. Accordingly, suppliers D1, . . . ,Dn are subsuppliers for suppliers C1, . . . ,Cn.

The logistic coordination between neighbored suppliers (interlinked participants) in the entire supply chain is accomplished by means of logistic fulfillment information exchanged between those suppliers, in the present embodiment using standard document templates 170, 172. The exchanged information is particularly used to co-ordinate local supply processes between interlinked participants in order to avoid supply bottlenecks between locally interlinked participants.

In addition, identical document templates 174, 176 are exchanged between other neighbored supply chain participants within the whole supply chain, e.g. document template 174 between subgroup E1, . . . ,En 126-130 and subgroup B1, . . . ,Bn 108-112. It is to be mentioned that identical document templates 178, 180 are also exchanged between a subgroup like A1, . . . ,An 102-106 and the supplied company 100 in order to let the supplied company 100 keep control of the overall supply chain process.

The described approach, on the one hand, relieves considerable management efforts from the supplied company insofar as the supplied company does not have to logistically co-ordinate the whole supply chain including all subchains and local subchain partner interdependencies.

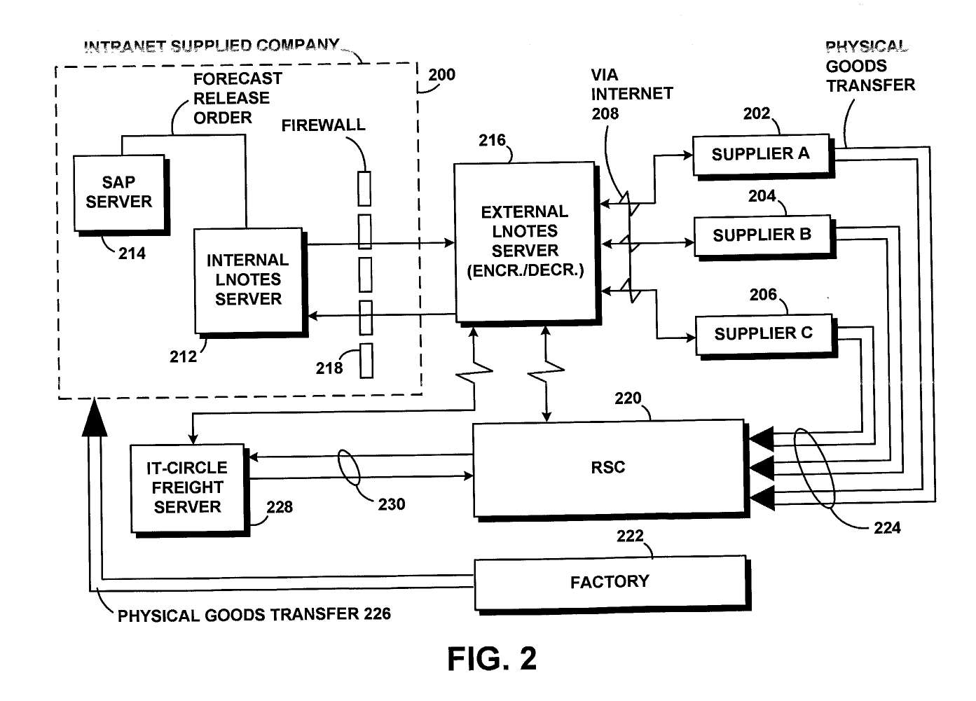

Referring now to FIG. 2, a preferred embodiment of a computer-implemented system for managing a supply chain in accordance with the invention is shown. The underlying supply chain, in this simplified drawing, consists of a supplied company 200 and a number of suppliers A-C 204-206. The whole supply chain hereby is managed using the Internet 208 as communication channel outside the supplied company 200 and using a proprietary intranet 210 inside the supplied company 200.

On the side of the supplied company 200, the whole supply chain is managed using an internal Lotus Notes™ (in the following “LNotes”) server 212 that is connected to an SAP™ server 214. The SAP server 214 is used to manage the whole supply chain on an administrative level wherein the LNotes server 212 is used to communicate with an external LNotes server 216 that is used to manage the necessary communication between the supplied company 200 and the suppliers 202-206 on the one hand and the communication between grouped suppliers as described above, on the other hand. Between the internal LNotes server 212 and the external LNotes server 216 a firewall 218 is arranged in order to secure the supplied company's 200 intranet 210 against unauthorized accesses from outside.

The SAP server 214, in particular, transmits release order information to the internal LNotes server 212. According to the invention, it additionally delivers replenishment forecast information to the internal Lnotes server 212 which then is further transferred to the suppliers 202-206.

Outside the intranet of the supplied company 200, the external LNotes server 216 is interconnected with each of the suppliers 202-206 via the Internet 208. In addition, the external LNotes server 216 is connected to a so-called Replenishment Service Center (RSC) 220 which again is connected to a factory 222 for assembling devices for the supplied company 200 using modules or parts obtained from the suppliers A-C 202-206. These modules or parts are physically transported from each supplier A-C 202-206 to the RSC 220 and the factory 222 via common transport channels 224 like known transport service companies.

The assembled devices are finally transported from the factory 222 to the supplied company 200 via another transport channel 226, designated herein as “physical goods transfer channels”” Physical transportation of the modules and the assembled devices is managed using a freight server 228 that is connected to the RSC 220 via data lines 230.

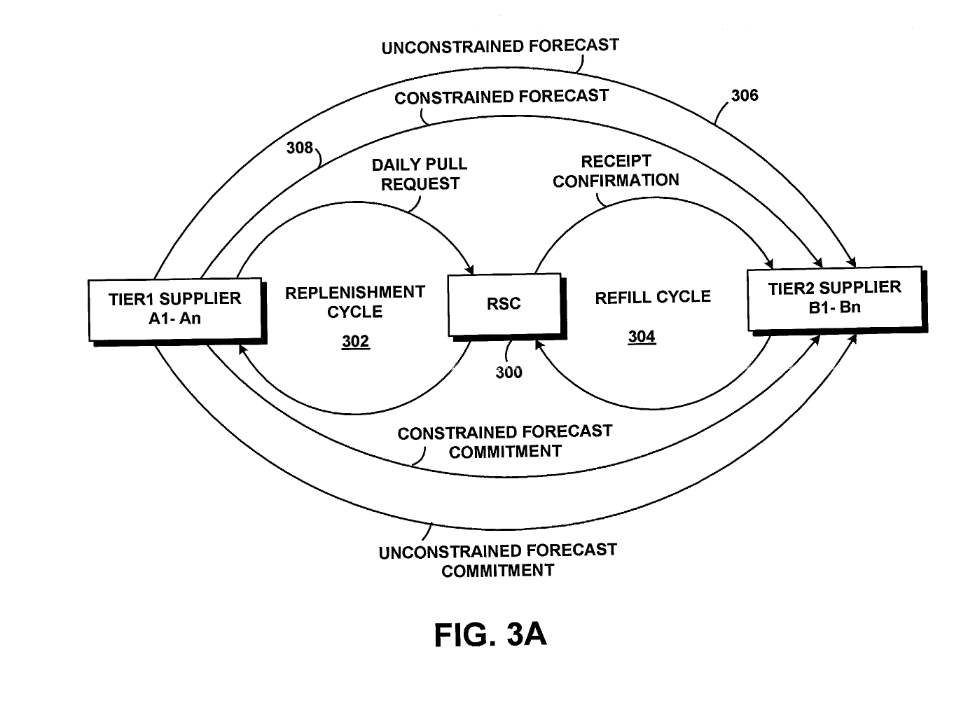

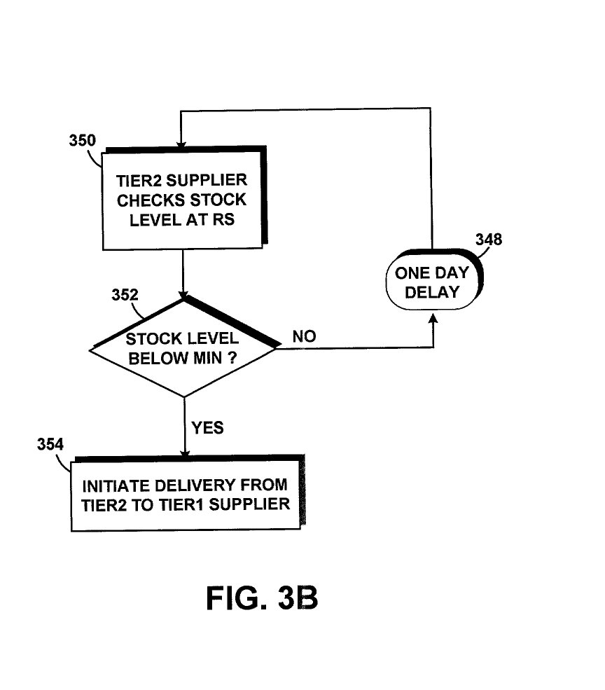

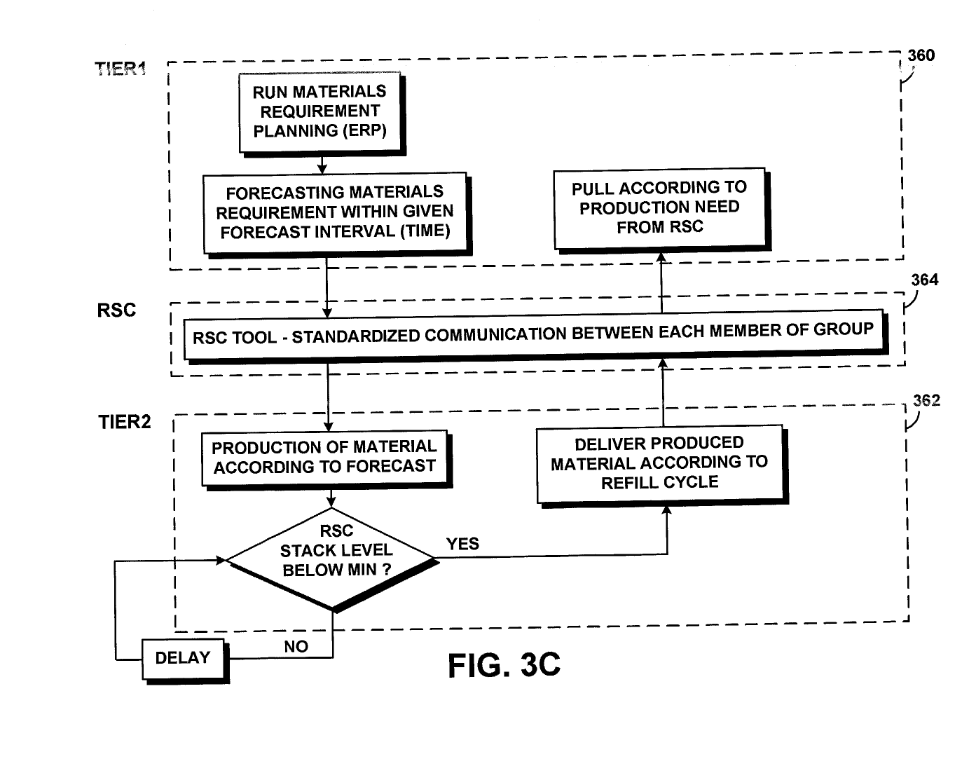

The entire supply chain management (SCM) process according to the invention is now described referring to FIGS. 3A-C illustrating a typical multi-tier communication protocol to be used between supply chain participants.

In FIG. 3A an entire SCM process is shown by way of a flow diagram. The SCM process is performed using a Replenishment Service Center (RSC) application 300 that co-ordinates a replenishment process active on the side of a supplier of each of the defined supplier groups and a refill process active on the side of a respective sub-supplier. A replenishment cycle 302 includes delivery of a regularly sent pull request, e.g. delivered on a daily time basis. A refill cycle 304, on the other hand, includes a receipt confirmation message sent from the RSC 300 to the sub-supplier, acknowledging receipt of certain supply material.

Further, in accordance with the invention, the SCM process has involved a forecast strategy in order to forecast supply figures between the two suppliers with a supplier group, e.g. in order to avoid supply bottlenecks between these partners or participants of the entire supply chain. The forecast strategy is divided into an unconstrained forecast process 306 where supply forecast is based on the assumption of unlimited supply capacity on the side of the subsupplier of each group of suppliers. The second part or forecast cycle is a constrained forecast process 308 which, in contrast to the unconstrained forecast 306, reflects real capacity constraints of the involved subsupplier of the group.

Now summarizing, the described SCM process provides the following main features:

Unconstrained and constrained forecast & commitment;

Scheduled agreement;

Inventory measurement; and

Scheduled pull requests & receipt confirmation.

The above approach enables a standard link between two direct partners of the supply chain. For the exchanged logistic information, data used on a regular time basis, e.g. for daily business, can be taken into account thus providing good data quality and clear responsibility. The approach, in addition, advantageously provides a fully transparent supply chain network in the sense that, for each customer/supplier relation along a given supply chain path, an effective, transparent, real time forecast/commit collaboration is provided.

According to the proposed SCM business process, each supplier is responsible to qualify its sub-suppliers etc., e.g. using the known ISO 9000 certification.

In FIG. 3B the basic process flow of a communication protocol according to the invention used between two suppliers on a group level is depicted by way of a flow diagram. With a one day time delay 348, a tier2 supplier regularly checks 350 the stock level a the RSC 300. If the stock level of certain supply materials is below a predefined minimum (MIN) 352, than delivery of those supply materials from tier2 supplier to tier1 supplier is initiated 354.

FIG. 3C depicts a more detailed process and material flow between a tier1 supplier 360 and a tier2 supplier 362 shown in FIG. 3B. The communication between the tier1 supplier 360 and the tier2 supplier 362 is managed by an above described RSC tool 364 according to another embodiment of the invention, such as described hereinafter in more detail. The RSC tool 364 provides standardized communication between each member of a supply chain group, as described beforehand.

On the tier1 level, at first a materials requirement planning process (ERP) is run for evaluating principle requirements for supply materials in the entire supply chain process. In a next step, supply materials requirements within a given (forecast) time interval are forecast. The forecast materials requirements are transferred to the tier2 supplier using the mentioned RSC tool. Tier2 supplier, in response to that forecast, produces materials in accordance with that forecast. In a following step, tier2 supplier checks if the current RSC stack level is below a predefined minimum (MIN). If the current stack level is not below that minimum then it returns to the beginning of that check box via a predetermined time delay that can lie between some hours or several days. If the current stack level is below the predefined minimum, the according supply materials are delivered to the RSC in accordance with the predescribed refill cycle. Tier1 supplier then can pull these materials according to current production needs from the RSC.

The above supply chain management process guarantees that the production of materials at each level of the supply chain, e.g. levels tier1 and tier2 as described above, is done so that all stock levels are lying within a given supply bandwidth, e.g. sufficient for 10-15 days. The described process step of forecasting supply requirements is mainly used for both, the combination of production of materials at the tier2 supplier level and control of the above described refill cycle whereby enabling use of the known parameter ‘days of supply’ (DOS).

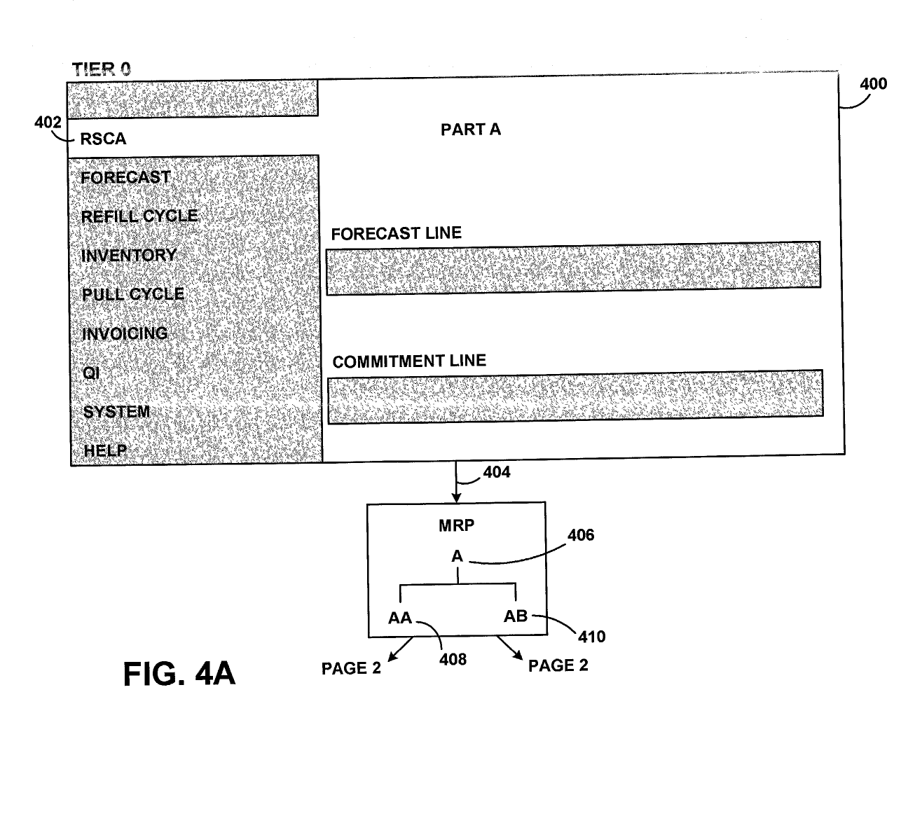

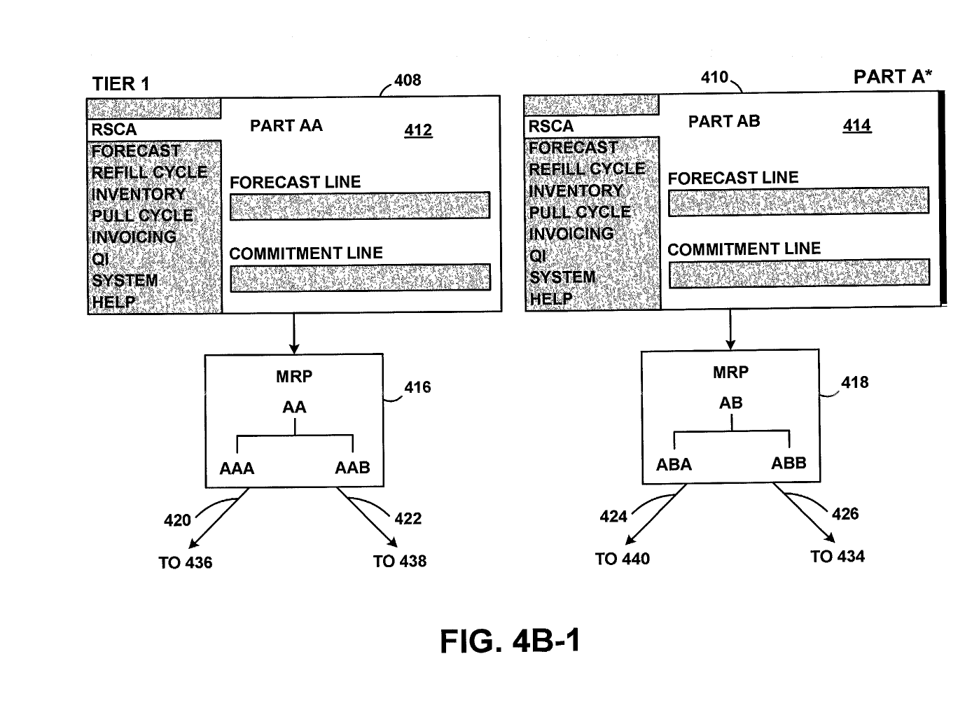

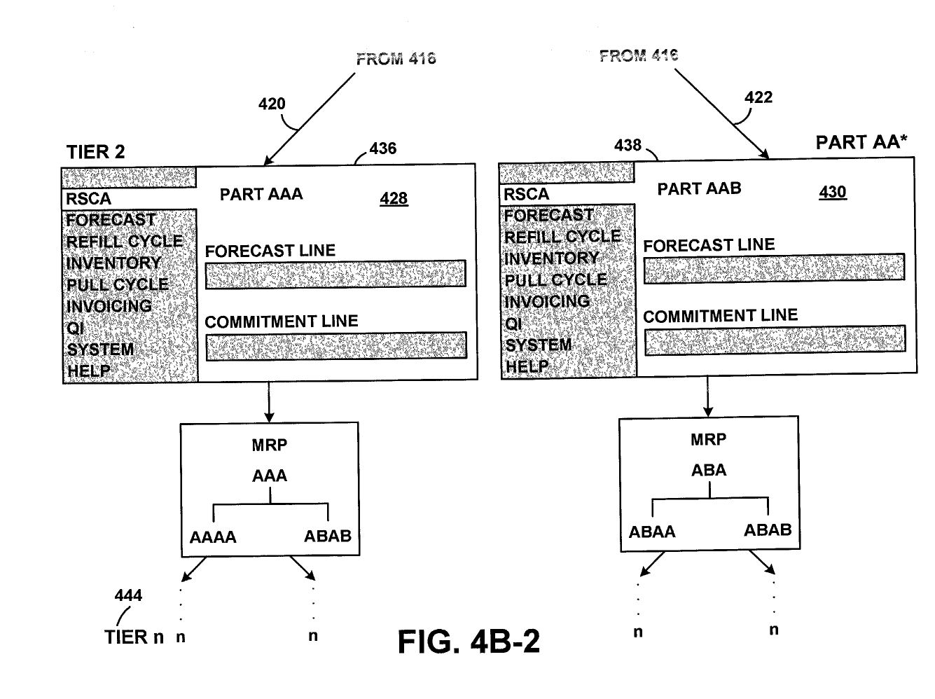

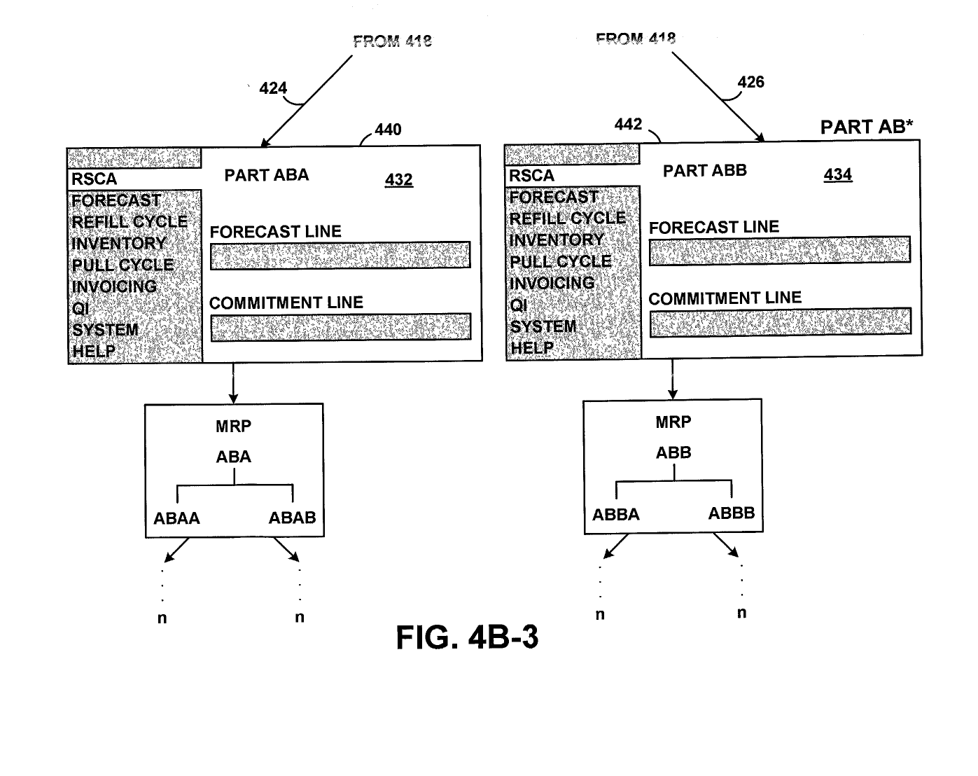

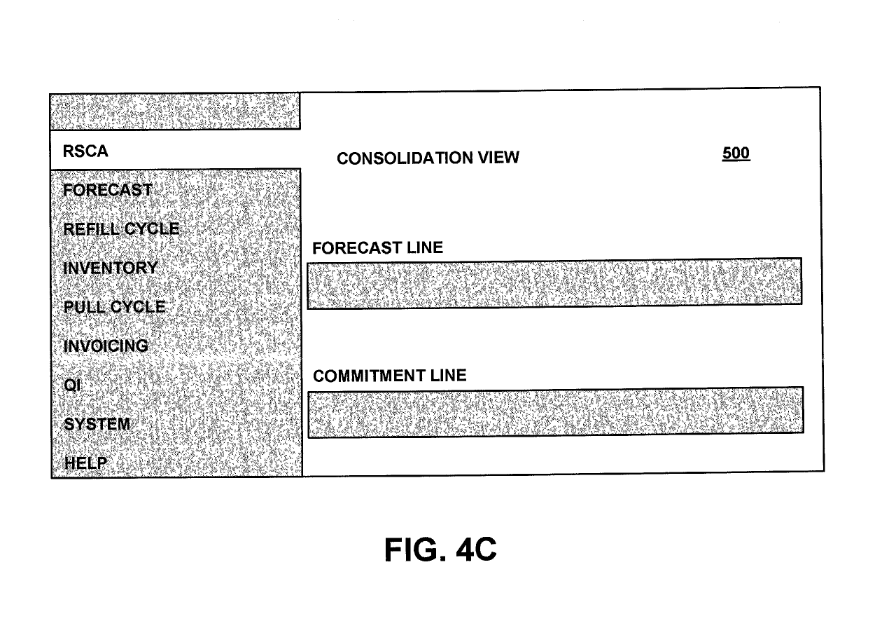

FIGS. 4A-4C schematically illustrate an embodiment of a preferred structure of a graphical user interface in accordance with the invention. FIG. 4A hereby depicts a schematic screen 400 of an exemplary tier0 supplier and the processing of a supply forecast related to necessary materials replenishment (MRP) calculation on its side. The schematic screen 400 clearly illustrates that the RSC application 402 uses a standardized process implemented in an RSC application program that is identical at each tier or layer of the underlying supply chain, which can be better illustrated referring to FIG. 4B. In the present example, the MRP calculation is performed by supplier A and the MRP calculation results, or supply forecast results respectively, are transferred 404 from supplier A 406 to subsuppliers AA 408 and AB 410 in order to fulfill the necessary supply requirements on that supply chain level.

FIG. 4B illustrates the further processing of the MRP results of the tier0 supplier(s) 406 obtained as described in FIG. 4A, the latter results representing the forecast results for the tier1 suppliers 408, 410, using accordingly standardized RSC screens 412, 414 on the side of the tier1 suppliers 408, 410. These results are further processed by the tier1 suppliers 408, 410 as MRP calculations 416, 418 wherein the results of the latter calculations are forwarded 420-426 to the RSC applications 428-434 of the corresponding tier2 suppliers 436-442. This procedure is repeated until reaching the lowest supply chain level 444 of tiern suppliers.

FIG. 4C schematically shows a sample screen of a Consolidated View 500 i.e. an overview of all relevant supply information from tier0 to tiern of the entire supply chain. For simplification purposes only, the reverse information flow via the Commitment Line is omitted in the drawing.

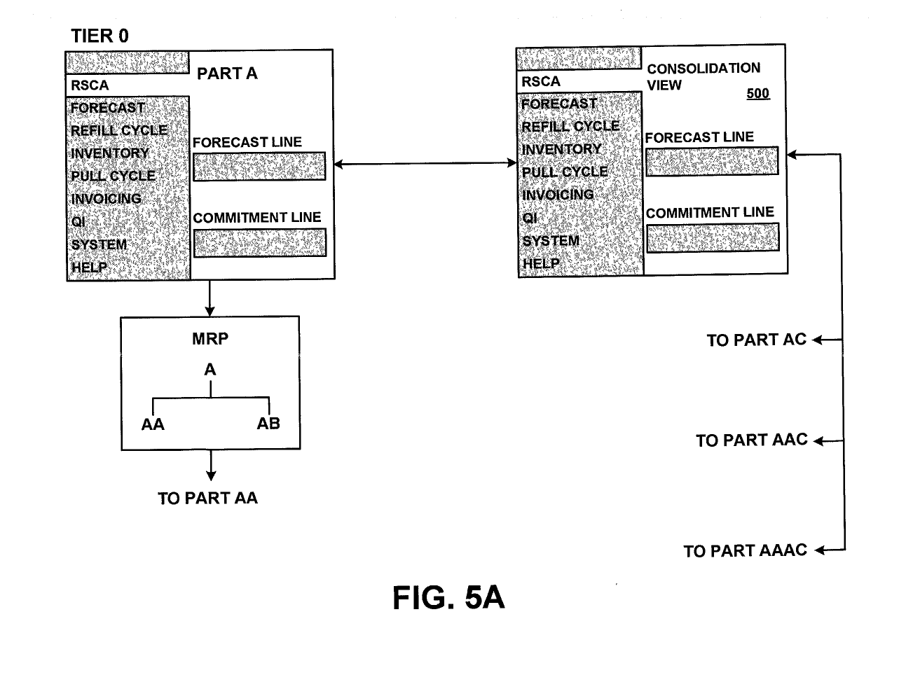

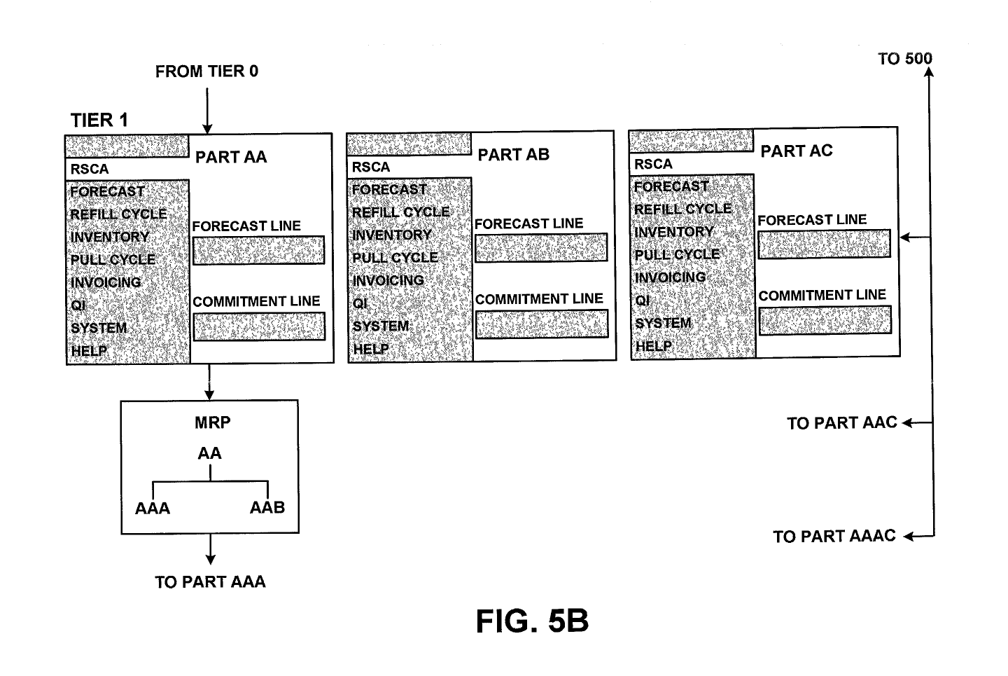

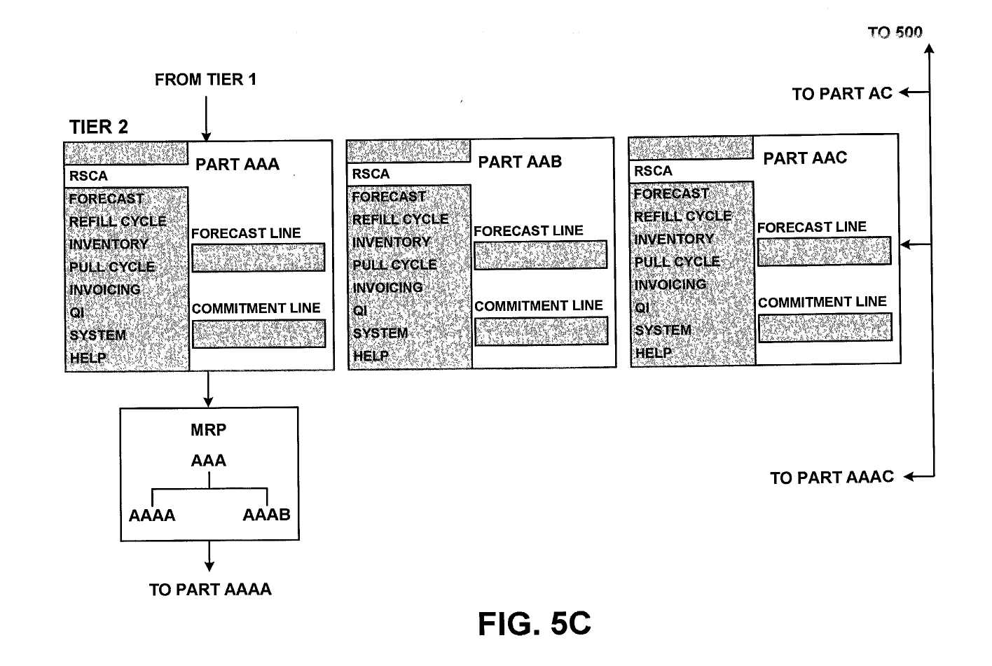

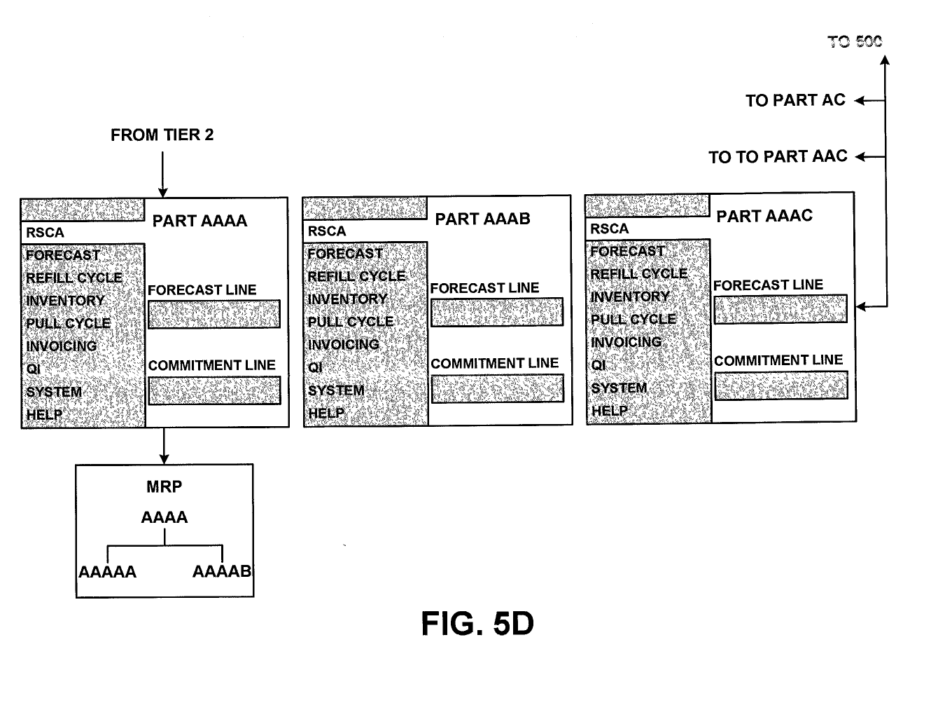

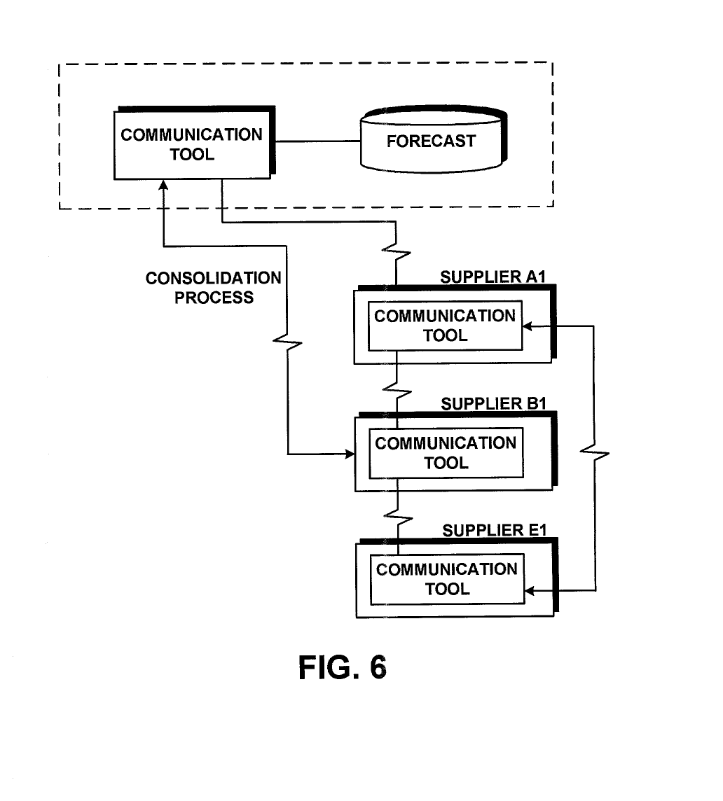

The above described supply chain management (SCM) solution, in addition, can be standardized as a standard process and, for instance, can provide a generic graphical user interface (GUI) as illustrated in predescribed FIGS. 4A-4C. FIG. 5 (FIGS. 5A-5D) summarizes the necessary interaction between all tiers of supply chain levels by way of a sequence of typical screenshots. The shown GUI sequence clearly illustrates grading and networking of all suppliers thus finally revealing the above mentioned Consolidated View 500.

The GUI particularly is used by all participants of the entire supply chain. The transparency and structured logistic information exchange along the whole supply chain improves continuity of supply, reduces inventory and increases speed. The particularly described supply chain management certification approach uses common SCM rules which apply to each supply chain participant and thus allow for frequent SCM audits along the entire supply chain. The described ‘Agreed-Upon’ measurements guarantee a robust SCM system.

The data structure and data fields of the exchanged document templates are the same in each hierarchical supply chain level. The underlying network, nevertheless, allows for consolidation and reporting along any given part of the entire supply chain thus allowing to keep control about the whole supply chain process.

A typical RSC network environment according to the invention is depicted in FIG. 5 in order to illustrate logistic fulfillment communication between supply chain participants connected to that RSC network.

On the side of all supply chain participants, including the supplied company, communication between all participants is accomplished using a communication tool. The communication tool is part of the RSC system and automatically creates event driven messages to the participants of the supply chain, i.e. warning that the commitment of specific suppliers is below a certain percentage or a stock level is below a predefined range, or that a new forecast has been posted. The events and addressees of the messages can be defined by the user. The communication tool, in addition, is connected to a database located on the side of the supplied company providing necessary information for conducting the RSC process described above referring to FIG. 3A.

The communication tools locally implemented at each supply chain participant, in the present embodiment, are directly interconnected with each other wherein the communication lines between two participants being group members of a predescribed supply chain group serve to manage locally supply requirements between those group members locally. In contrast to that, communication lines between participants not neighbored, including the lines between suppliers and the supplied company, are used for consolidation of the underlying SCM process.

What is claimed is:

1.A method of managing a supply chain of digitally networked supply chain participants, comprising:
identifying at least two supply chain participants in the supply chain being linked directly within the supply chain;
grouping the at least two supply chain participants;
determining, on the side of each of the at least two grouped supply chain participants, logistic fulfillment requirements for providing local supply activities to the at least other supply chain participant of the grouped supply chain participants;
exchanging logistic fulfillment information between the at least two supply chain participants for controlling the local supply activities;
controlling the supply chain, on the side of each of the at least two supply chain participants, dependent on the content of the exchanged logistic fulfillment information.

2. The method according to claim 1, wherein the logistic fulfillment information is exchanged using a standardized communication protocol between the supply chain participants.

3. The method according to claim 1, wherein providing a binary tree correlating with the logistic structure of the supply chain to be managed and providing, at each node of the binary tree, a document template for the logistic fulfillment information to be exchanged.

4. The method according to claim 2, wherein the standardized communication protocol is implemented using a standardized graphical user interface.

5. The method according to any of claims 2, wherein the standardized communication protocol automatically creates event driven messages to the participants of the supply chain.

6. The method according to claim 5, wherein the event driven messages include warning that the commitment of specific suppliers is below a predefined percentage.

7. The method according to claim 5, wherein the event driven messages include warning that a stock level is below a predefined range and/or that a new forecast has been posted.

8. The method according to claim 5, wherein the events and addressees of the messages are defined by a user.

9. The method according to claim 1, wherein performing, as a first process cycle, an unconstrained forecast process where supply forecast is based on the assumption of unlimited supply capacity on the side of the subsupplier of each group of suppliers, and performing, as a second process cycle, a constrained forecast process treat reflects real capacity constraints of the involved subsupplier of the group.

10. The method according to claim 1, wherein providing a standardized communication tool synchronously providing the same logistic fulfillment information to each supply chain participant, the logistic fulfillment information related to local fulfillment forecast being used for physical goods replenishment.

11. A computer usable medium having stored a computer program for the management of a supply chain consisting of digitally networked supply chain participants, comprising:
a first set of instruction codes for digitalizing the supply chain;
a second set of instruction codes for identifying at least two supply chain participants in the digitalized supply chain being linked directly within the supply chain;
a third set of instruction codes for grouping the at least two supply chain participants;
a fourth set of instruction codes for determining, on the side of each of the at least two grouped supply chain participants, logistic fulfillment requirements for providing local supply activities to the at least other supply chain participant of the grouped supply chain participants;
a fifth set of instruction codes for enabling an exchange of logistic fulfillment information between the at least two supply chain participants; and
a sixth set of instruction codes for controlling the supply chain, on the side of each of the at least two supply chain participants, dependent on the content of the exchanged logistic fulfillment information.

12. A computer implemented system for the management of a supply chain consisting of digitally networked supply chain participants, comprising:
first processing means for digitalizing the supply chain, for identifying at least two supply chain participants in the digitalized supply chain being linked directly within the supply chain, for grouping the at least two supply chain participants, for determining, on the side of each of the at least two grouped supply chain participants, logistic fulfillment requirements for providing local supply activities to the at least other supply chain participant of the grouped supply chain participants;
communication means for enabling an exchange of logistic fulfillment information between the at least two supply chain participants;
at least second processing means for controlling the supply chain, on the side of each of the at least two supply chain participants, dependent on the content of the exchanged logistic fulfillment information.

13. The system according to claim 12, further comprising a standardized communication protocol for exchanging the logistic fulfillment information between the supply chain participants.

14. The system according to claim 12, further comprising a digital binary tree correlating with the logistic structure of the supply chain to be managed which, at each node provides a template for the logistic fulfillment information to be exchanged.

15. The system according to claim 13, further comprising a graphical user interface for handling the standardized communication protocol.

16. The system according to claim 12, further comprising means for performing an unconstrained forecast process where supply forecast is based on the assumption of unlimited supply capacity on the side of the subsupplier of each group of suppliers and for performing a constrained forecast process that reflects real capacity constraints of the involved subsupplier of the group.

17. A computer program product for the management of a supply chain consisting of digitally networked supply chain participants, comprising:
a first set of instruction codes for digitalizing the supply chain, for identifying at least two supply chain participants in the digitalized supply chain being linked directly within the supply chain, for grouping the at least two supply chain participants, and for determining, on the side of each of the at least two grouped supply chain participants, logistic fulfillment requirements for providing local supply activities to the at least other supply chain participant of the grouped supply chain participants;
a second set of instruction codes for enabling an exchange of logistic fulfillment information between the at least two supply chain participants; and
a third set of instruction codes for controlling the supply chain, on the side of each of the at least two supply chain participants, dependent on the content of the exchanged logistic fulfillment information.
